(19) United States
(12) Patent Application Publication
(10) Pub. No.: US 2012/0026836 A1
(43) Pub. Date: Feb. 2, 2012

(54) Proximity timer switch

(76) Inventors: Lucian Scripca, San Marcos, CA (US); Valentina Scripca, San Marcos, CA (US)

(21) Appl. No.: 13/068,641

(22) Filed: May 18, 2011

Related U.S. Application Data
(60) Provisional application No. 61/400,745, filed on Aug. 2, 2010.

(51) Int. Cl. G01S 15/08

(52) U.S. Cl. 367/99

(57) ABSTRACT

A timer switch which is activated by the proximity of an object situated in a given distance range and is present there for a given time period.

### CROSS-REFERENCE TO RELATED APPLICATION

The present application claims priority based on the similarly entitled U.S. Provisional Patent Application Ser. No. 616/400,745 filed Aug. 2, 2010 naming Lucian Scripca and Valentina Scripca, the entire disclosure of which is hereby incorporated by reference.

### REFERENCES CITED

### Referenced by

U.S. Patent Documents

| | | |
|---|---|---|
| 4,131,872 | August 1982 | Kearns; William F. |
| 2,333,688 | November 1943 | Shepard, Jr. |
| 3,031,644 | April 1962 | Hisserich et al. |
| 3,065,455 | November 1962 | Roth |
| 3,597,754 | August 1971 | Lerner |
| 3,729,702 | April 1973 | Beeken et al. |
| 3,881,353 | May 1975 | Fathauer |
| 4,260,980 | April 1981 | Bates |
| 4,263,665 | July 1981 | Watts |
| 4,290,126 | September 1981 | McFadyen et al. |

### FIELD OF INVENTION

This invention relates to proximity switches and timer switches, particularly timer switches, which get activated by an object which enters a given range of proximity and stays in that range for a given period of time.

### BACKGROUND OF THE INVENTION

The prior art, as exemplified in U.S. Pat. Nos. 4,131,872, 2,333,688, 3,031,644, 3,065,455, 3,597,754, 3,729,702, 3,881,353, 4,260,980, 4,263,665, 4,290,126 contains a number of automated devices which measure or detect the proximity to an object, or have a delay between the detection of an object and the actuation of a switch, or both. In the present invention the activation switch is turned on only if an object is detected at a precise distance, or range of distances, from the proximity timer switch, for a precise amount of time. If the object moves out of the range, before the time ran out, the unit does not turn on the activation switch. This invention applies best as a security device, where an access way which was left open unintentionally, will closed automatically after a period of time, and even more specifically, the invention applies better to older garage doors, where chances are they are left open after the car was driven out, leaving open access to the house.

### SUMMARY OF THE INVENTION

The invention is summarized in a proximity timer switch which sends out a signal when it detects an object in a given range of proximity for a given period of time. The proximity timer switch has a momentary switch which, when activated, pauses the proximity timer switch indefinitely as long as the object is detected in the given range. Activating the momentary switch again, causes the proximity timer switch to run again. When the proximity timer switch was paused and the object moved out of the range, the proximity timer switch starts running again.

### BRIEF DESCRIPTION OF THE DRAWINGS

FIG. 1 is a schematic representation of the way the proximity timer switch works: A burst of sonic waves, also known as ping, (6) is released by the proximity timer switch (1) and travels outwards, in a cone shaped wave until reflected back (7), also known as echo, by an object (2) or (3). The proximity timer switch (1) calculates the distance to the object by multiplying the speed of sound in the air by half of the time from when the ping is sent until the echo is detected.

D=V(sound)*(Techo−Tping)/2

### Where:

D is the distance from the proximity timer switch (1) to the object (2) or (3),
Techo is the time when the returning wave (7) is detected,
Tping is the time when the wave (6) was generated from the proximity timer switch
Vsound is the speed of sound in the air, approximately 343 meters per second.

If the calculated value of the distance D falls in between DMIN and DMAX, DMIN<D<DMAX, then the object (2) is confirmed to be located inside the active zone (8). The proximity timer switch repeats the procedure at set period of time, delta t, for a set number of times N. The condition for the proximity timer switch to activate is that the condition DMIN<D<DMAX is satisfied N times, or every time it measures the distance to the object must be between DMIN and DMAX. If the object is, or moves outside the active zone (3), all measurements are ignored, or deleted.

All above determinations are made under the assumption that the measurements are made inside the sonic wave's cone of propagation.

FIG. 2 represents the block schematic of a possible implementation of the proximity timer switch, comprised of a power supply (9), an LED signaling block (10), an acoustic annunciator (11), a general on/off switch, a acoustic transducer (13), the logic control circuit (14), a user input block (15), an optional delay switch (16), and the output relay (17) with its contacts (18). The main building blocks are:

The acoustic transducer (13) with the role of generating the acoustic wave, ping, when driven by a corresponding input signal and generating an electric signal when detecting an acoustic wave, echo,

The logic control circuit (14), which provides all the sonar functions, does all the calculations to determine if the condition for detection are satisfied, takes input from the user, measures the power

The rest of the blocks are, and not limited to:

The power supply (9), does the conversion from the existing standard power supplies, such as battery or wall outlet, to the exact voltages needed by the electronic circuits in the proximity timer switch,

The optical signaling block (10), comprised of light sources, such as light emitting diodes (LEDs), light bulbs or liquid crystal displays (LCDs), which signal to the user the different states in which the proximity timer switch is, such as, abort mode, run mode, alert mode, and other modes,

The acoustic annunciator block (11), sends audible signals in accordance to different states which need to get the user's attention, such as low battery, alert before activating the output relay, push button feedback and more,

The on/off switch is optional and switches off the unit, to preserve power when not in use,

The push button (15), takes input from the user to switch between run and abort modes, with other possible functions to be implemented as needed,

The optional delay switch (16), gives the user a means to adjust the delay of the unit,

The output relay activates an external process when the detection of the object met the distance and time requirements, meaning the object was detected always inside the active zone during the delay time.

FIG. 3 depicts the proximity timer switch (19) used as an automatic garage door closer. The proximity timer switch (19) monitors the garage door (22) which is pulled open by the garage door opener (20). In this example, the screw (23) rotates, moving the slider (21) which is attached to the last panel of a segmented garage door. The door opens or closee guided by the rail (25). The two contacts of the proximity timer switch (19) are connected to the garage door opener (20) open/close contacts by a pair of wires (26). Once the garage door is detected in the active range of the proximity timer switch (19) for a given amount of time, it will activate the output relay of the proximity timer switch, causing the garage door opener (20) to close the garage door (22). All the other ways the garage door opener is activated, like push button on the wall and remote control are not affected by the proximity timer switch, the latter just adding a new security feature to it. More, the light barrier and the pressure detection security systems are still in effect.

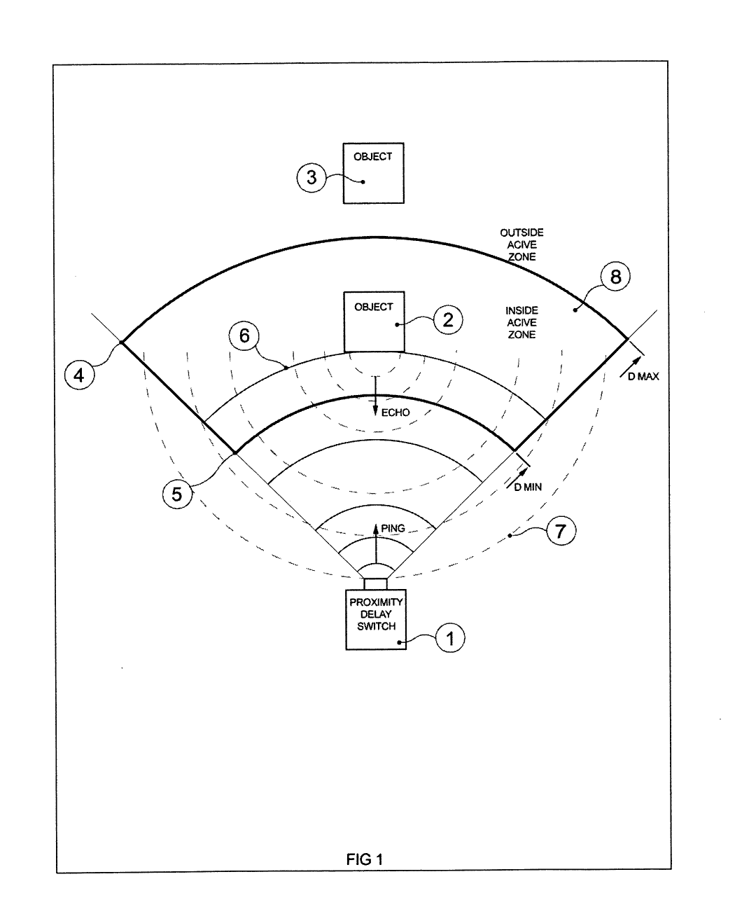

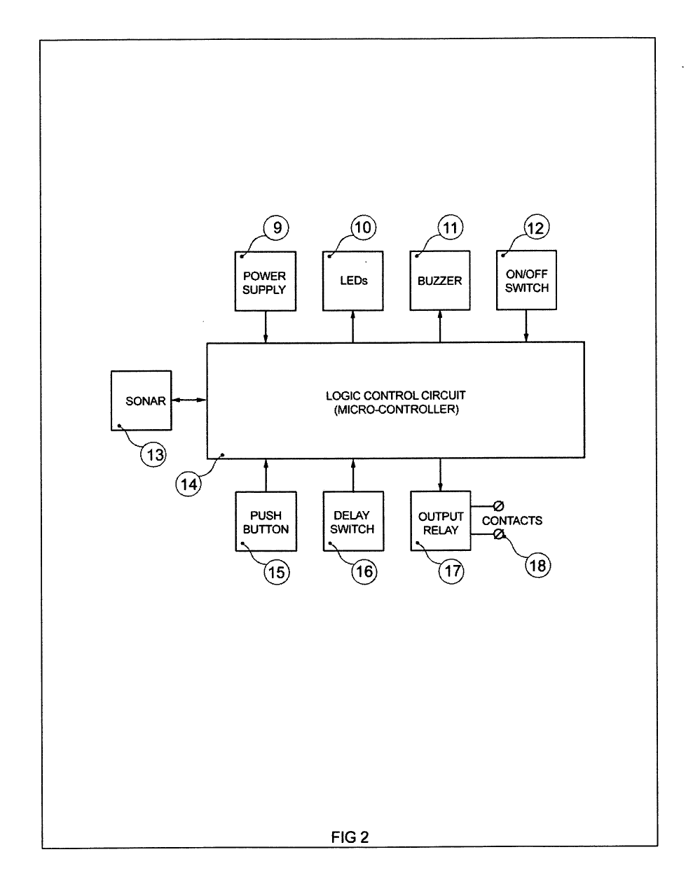

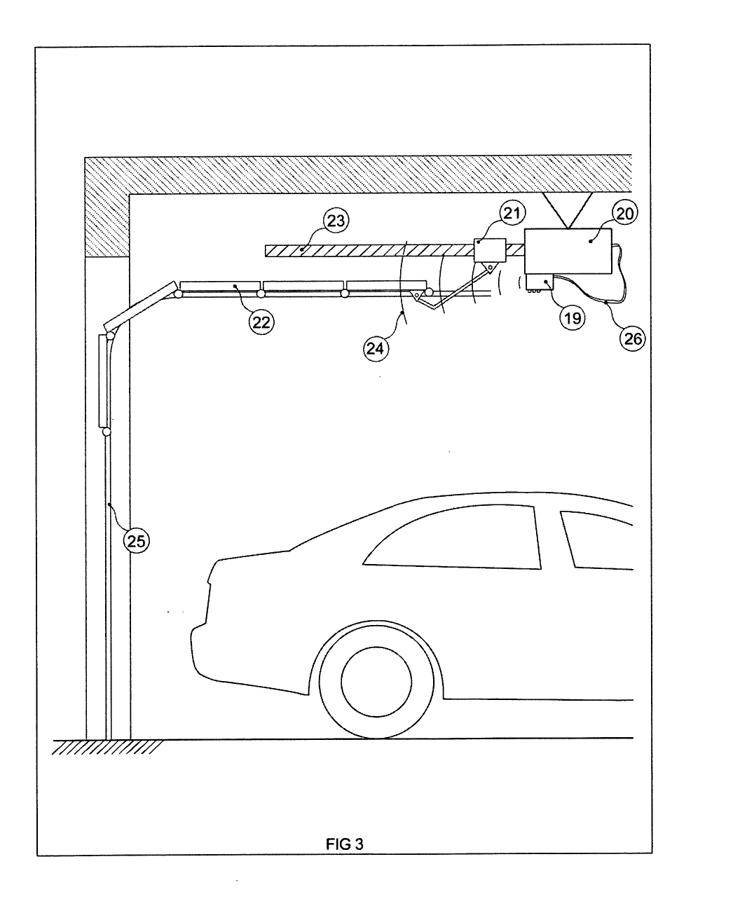

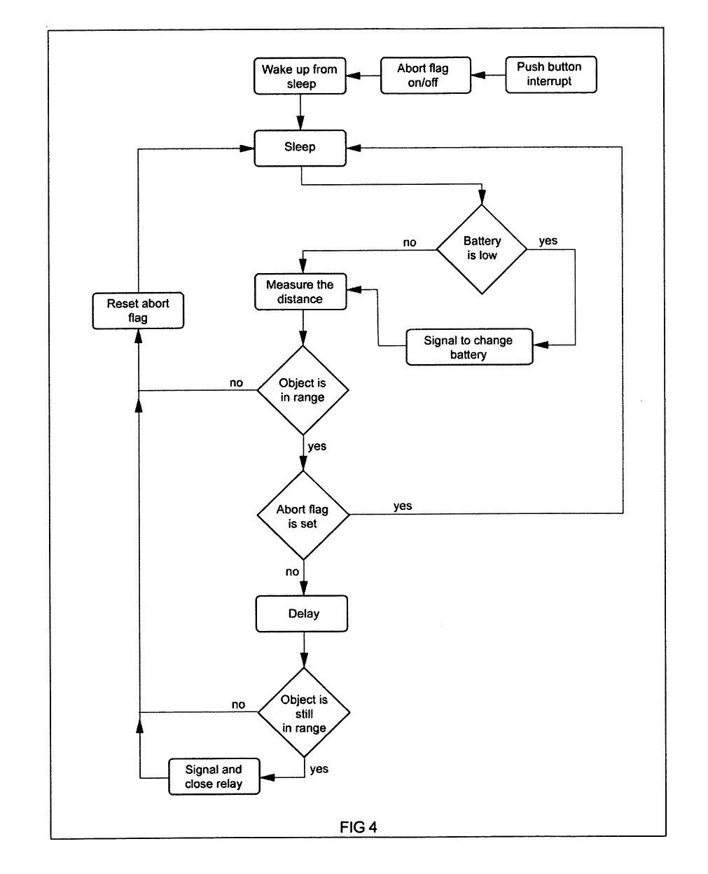

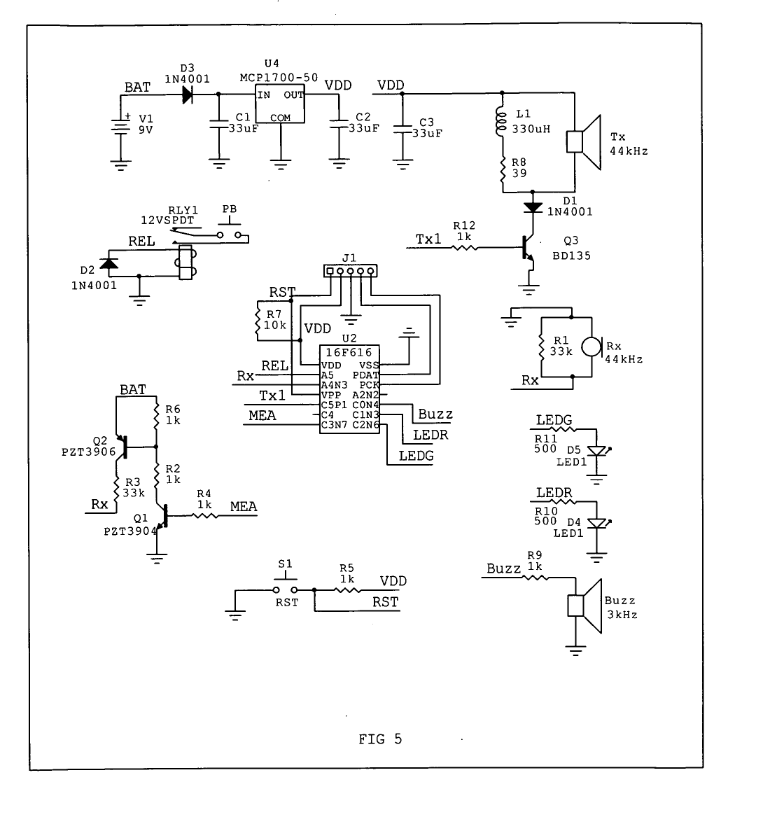

FIG. 4 is one of many possible operational program flowcharts that can be embedded in the logic control circuit of the proximity switch, allowing the invention to function as an automatic garage door closer. Not present in this figure, and needed for explaining the flowchart is a user input device, like a push button for example, that will force an interrupt routine to be performed. The proximity timer switch is the vast majority of the time in Sleep mode, this way a very long battery life can be achieved. Periodically a Wakeup from sleep activates the battery check routine. If the battery has enough charge a distance measurement is done. If the battery is discharged, an audible signal is generated, until the battery gets replaced. The distance which has been measured determines if an object, in this case the garage door, is located inside the active zone of the proximity timer switch. If an object is detected, and the push button has not been activated, the distance measurement is done again in case the object is still in the active zone, as described in FIG. 1, an audible signal is generated a certain amount of times and the output relay is activated, closing the garage door. If, at any time, the push button is activated, the interrupt routine sets an Abort flag which will drive the program to Sleep mode as long as the object is in the active zone. This function allows one to force the garage door to stay open. The Abort flag can be reset by activating the push button or by closing the garage door, meaning the object in not detected in the active zone anymore.

FIG. 5 represents one of the many possible implementations of the proximity timer switch schematic diagram. The schematic can be better described by the main functional blocks with the corresponding attached components. The logic block is built around the micro-controller U2. The logic block is designed to execute the majority of functions with the least number of interface circuits, in order to minimize the overall cost. Along this line, the micro-controller U2 generates the ultrasonic signal used to drive the ultrasonic transmitter Tx, receives and processes the echo detected by the ultrasonic receiver Rx, measures the energy level of the battery VI in conjunction with the circuit Q1, Q2, R2, R3, R4 and R6, drives the optical enunciators D5 and D4, drives the audible annunciator Buzz, and drives the output relay RLY1. The power supply is regulated by the low quiescent current voltage regulator U4, filtered by the capacitors C1, C2 and protected for reverse polarity by the diode D3. The push button 51 generates an interrupt in the program flow in order to deactivate the output relay.

### DETAILED DESCRIPTION OF THE INVENTION

As illustrated in FIG. 1 through FIG. 5 the invention is embodied in a proximity timer switch acting as an automatic garage door closer.

The proximity delay switch (1) in FIG. 1 transmits a burst of ultrasonic sound (ping) in FIG. 1 through the air. The wave (6) in FIG. 1 propagates ahead until it reaches an obstacle (2) in FIG. 1. and is reflected back (echo) in FIG. 1 to the proximity delay switch (1) in FIG. 1.

The distance from the proximity delay switch and the obstacle (2) in FIG. 1 is calculated multiplying the speed of sound in the air, Vs=343.2 m/s (in normal condition of temperature, pressure and humidity), by half the time (ts) that took the ultrasonic wave to go from the proximity delay switch (1) in FIG. 1 to the object and back (7) in FIG. 1:

D=½Vs*ts

The scope of this invention is to signal when the object (2) in FIG. 1 is situated between a minimum distance D MIN (5) in FIG. 1 and a maximum distance D MAX (4) in FIG. 1, or it is located inside the active detection zone (8) in FIG. 1 for a given period of time. In the case of the preferred embodiment, the garage door closer, the proximity of the object would signify the garage door being opened, and the period of time would allow the garage door to stay open for a period of time in which the car can safely enter or exit the garage. To exceed this time means either the garage door was intentionally left open, or the garage door was forgotten open. When the garage door is intentionally left open, the user must suspend the garage door closer's function by pressing a switch. The garage door closer will then wait for another button press, or for the garage door to close once in order to re-start monitoring the proximity. When the object of the detection is situated in an area outside the active zone, the garage door closer is not signaling the presence of the object, or comes out of the suspend mode.

The proximity delay switch has a logic control circuit that works according to the flow chart depicted in FIG. 4 as follows: most of the time, the circuitry is in sleep mode, to conserve energy, in this case battery life. Periodically, the logic control circuitry comes out from sleep mode, and performs a cycle of operations. The battery state of charge is checked, and if the battery is low, an audible signal is transmitted, to prompt the user to replace the battery with a fresh one. If the battery charge checks good, the proximity timer switch performs a distance measurement to the closest object in front of it. The suspend or abort switch, if pressed, sets an abort flag, at any time in the cycle. If an object, in this case the garage door, is inside the active zone, or open, and the abort flag is not set, a delay is activated, after which, if the garage door is still open, the garage door is closed, the abort flag is reset, and the unit goes into sleep mode. During the cycle, if the abort flag is set, the unit goes into sleep mode performing only the battery check.

The proximity timer switch main functional blocks are the logic control circuit, usually a micro-controller, FIG. 2 (14), programmed to perform the logic functions described by the flowchart in FIG. 4. A power supply, FIG. 2 (9), converts the voltage provided by the standard supply, like a battery, adaptor or mains, into the proper voltage levels needed by the circuit. The sonar, FIG. 2 (13) generates the ultrasonic wave burst (ping) and converts the ultrasonic reflected wave (echo) into an electric signal, further processed by the logic control unit and converted into a number representing the distance to the nearest object in front of the sonar. LEDs of different colors FIG. 2 (10) are turned on and off by the logic control circuit and signal to the user at certain time intervals the state of the suspend flag, whether the unit is active or in suspend mode, as an example, flashing green for active and flashing red for suspended mode. The buzzer FIG. 2 (11), signals by means of audible sound either the fact that the garage door is about to close, a beep per second for 10 seconds, followed by two beeps per second on the last five seconds, and also the buzzer signals if the battery is low, by means of short beeps, every time the circuit wakes up from sleep mode. The push button in FIG. 2 (15), when pressed places the unit into suspend mode. A delay switch FIG. 2 (16), provides a manual way to adjust the time interval in which the garage door is allowed to remain open. The contacts in FIG. 2 (18) of output relay in FIG. 2 (17) are connected in parallel with the push button wires in FIG. 3 (26) coming from the garage door opener main unit FIG. 3 (20). A main on/off switch in FIG. 2 (12) allows turning off the unit's power. For reference in FIG. 3 is depicted a typical garage door with the proximity timer switch (garage door closer) attached to it, where (19) is the proximity timer switch facing the garage door (22). The ultrasonic wave burst (24) periodically is looking for the door. Other elements are the garage door closer chain or in this case screw (23) and the shuttle (21), physically connected to the garage door which rolls guided by the side tracks (25).

The electronic schematic diagram in FIG. 5 depicts a simple and inexpensive way of implementing the proximity timer switch. A microcontroller U2, holds in the program memory the logic functionality depicted in the flowchart in FIG. 4. The power from the battery (BAT) is converted by the voltage regulator U4 into 5VDC (VDD). Periodically, the battery monitor circuit Q2 and 01 applies a load to the battery and sends the voltage to an analog to digital converter, in this circuit, part of the microcontroller U2. The sonar is built around the 44 kHz ultrasonic transducers, Tx and Rx, and the related circuitry. The signaling elements are the red LED (LEDR), the green LED (LEDG) and the Buzzer (Buzz). The suspend switch is 51 and the output relay is RLY1. The microcontroller U2 sends an electric signal of 44 kHz to the transistor Q3 which drives the ultrasonic transducer Tx generating an ultrasonic sound wave (ping), after further applied to the microcontroller analog to digital converter. The program calculates the distance to the object and makes the appropriate decisions, in conjunction with the signals received from the suspend switch and battery status circuit and the length of time the object has been detected.

Following is the listing of the main function saved in the microcontroller program memory, that is governing the proximity timer switch. The code is written in the C programming language.

What is claimed is:

1. A proximity timer switch, which sends on output signal when an object is detected in a given range of distance for a given period of time comprising;
a sonar,
said sonar sends an acoustic signal through the air and then measures the distance by multiplying the speed of sound with half of the time it takes the sound to reach to and bounce back from the object
a delay control,
said delay control having a switch selectable delay period which provides input to a micro-controller relative to the delay selected,
a logic control,
said logic control is a micro-controller used to store the program which runs the proximity timer switch, generates the acoustic signal, drives the acoustic transducer, samples the output of the acoustic receiver, computes the real distance to the reflecting object, drives LEDs for signaling purposes, monitors switches used for setting the timer delay and abort functions, drives the piezoelectric speaker and periodically enters Sleep mode to conserve energy.
a power supply,
said power supply provides the energy for the proximity timer switch
a main on/off switch,
said main on/off switch used to power up and power down the proximity timer switch,
acoustic annunciator,
said acoustic annunciator comprising of a piezoelectric device, signals different phases of the program, like ready to activate, and low battery,
optical annunciators,
said optical annunciators comprising of colored light emitting diodes (LEDs), signal with a periodic pulse that the unit works, and if it is set to run or to pause,
a momentary switch,
said momentary switch is used to make changes in program while the proximity timer switch is running, including pause and run, calibration, start and stop,
an activation switch,
said activation switch is a relay activated by the logic control, which signals that the unit detected an object in the qualifying range for the qualifying time period,
an enclosure,
said enclosure contains all the proximity timer switch parts, and has openings for the input and output devices, such as LEDs, buttons, acoustic transducers, and activation switch contacts.
enclosure mounting hardware,
said enclosure mounting means are adhesive magnetic and velcro tape, which help locate the proximity timer switch on most surfaces, and allows easy orientation towards the direction the object for detection might show up.

2. A proximity timer switch as claimed in claim 1 wherein the sonar uses a single ultrasonic transducer for both transmitting and receiving, being switched automatically by the logic control unit in accordance with the stage of the measurement, transmit or listen for the echo.

3. A proximity timer switch as claimed in claim 1 wherein the sonar uses a couple of ultrasonic transducers, one for transmitting and the second for receiving.

4. A proximity timer switch as claimed in claim 1 wherein the momentary switch is a tactile switch, based on a conductive dome being pressed to snap and short a circuit on the printed circuit board.

5. A proximity timer switch as claimed in claim 1 wherein the momentary switch is a proximity capacitive touch switch.

6. A proximity timer switch as claimed in claim 1 wherein the momentary switch is a proximity optical switch.

7. A proximity timer switch as claimed in claim 1 wherein the momentary switch is a resistive touch switch.

8. A proximity timer switch as claimed in claim 1 wherein the activation switch is a relay.

9. A proximity timer switch as claimed in claim 1 wherein the activation switch is an optical output.

10. A proximity timer switch as claimed in claim 1 wherein the activation switch is a radio frequency output.

11. A proximity timer switch as claimed in claim 1 wherein the activation switch is a displacement actuator.

12. A proximity timer switch as claimed in claim 1 wherein the activation switch is a magnetic field output,

13. A proximity timer switch as claimed in claim 1 wherein the power supply is a battery pack.

14. A proximity timer switch as claimed in claim 1 wherein the power supply is a battery.

15. A proximity timer switch as claimed in claim 1 wherein the power supply is external.

16. A proximity timer switch as claimed in claim 15 wherein the power supply comes from a standard wall outlet, properly transformed to power the device.

17. A proximity timer switch as claimed in claim 15 wherein the power supply comes from a solar panel, properly transformed to power the device.

18. A proximity timer switch as in claim 1 which is paused from running when the momentary switch is activated and stays paused only as long as the object is detected in the given proximity and starts running again after the object is no longer detected in the given proximity.
